(19) United States
(12) Patent Application Publication
(10) Pub. No.: US 2017/0188095 A1
(43) Pub. Date: Jun. 29, 2017

(54) METHOD AND ELECTRONIC DEVICE FOR WEB VIDEO CAPTURING

(71) Applicants: Le Holdings (Beijing) Co., Ltd., Beijing (CN); LE SHI INTERNET INFORMATION & TECHNOLOGY CORP. BEIJING, Beijing (CN)

(72) Inventor: Jincheng ZHAO, Beijing (CN)

(21) Appl. No.: 15/250,650

(22) Filed: Aug. 29, 2016

Related U.S. Application Data
(63) Continuation of application No. PCT/CN2016/088955, filed on Jul. 6, 2016.

(30) Foreign Application Priority Data
Dec. 23, 2015 (CN) 201510977935.X

(51) Int. Cl. H04N 21/442; H04N 21/44; H04N 21/845; H04N 21/231; H04N 21/475

(52) U.S. Cl. CPC H04N 21/44222; H04N 21/231; H04N 21/4758; H04N 21/845; H04N 21/44008

(57) ABSTRACT

Disclosed are a method and an electronic device for web video capturing, the electronic device for web video capturing collect related information of various channels, and calculate popularity of the various channels according to the collected related information of the various channels; collect release time of videos on the various channels to establish a time table for updating the videos; calculate next update time of the videos on the various channels according to the popularity of the various channels and the time table for updating the videos; determine capture time of the videos on the various channels according to the next update time of the videos on the various channels; and capture the videos on the various channels according to the determined capture time of the videos on the various channels.

### CROSS REFERENCE TO RELATED APPLICATIONS

The present disclosure is a continuation of International Application No. PCT/CN2016/088955, filed on Jul. 6, 2016, which is based upon and claims priority to Chinese Patent Application No. 201510977935.X, filed on Dec. 23, 2015, the entire contents of all of which are incorporated herein by reference.

### TECHNICAL FIELD

The disclosure relates to the technical field of network search, and more particularly, to a method and an electronic device for web video capturing.

### BACKGROUND

To enrich the content for video search in the website, using a periodically polling mechanism is extensively used to capture the video data on YouTube. However, periodically capturing video data resources from YouTube by traversing hundreds of thousands of channels thereon consumes a huge number of resources. Specific to various channels, different channels have different total playing quantities, video quantities and subscription quantities, and different channels have different update periods. Hence, the periodically polling is subjected to severe defects in terms of timeliness and resource waste.

In view of the above, embodiments of the present disclosure provide a web video capturing method and a web video capturing apparatus, which achieve high timeliness during web video capturing and save network resources during web video capturing.

### SUMMARY

The present disclosure provide a method and an electronic device for web video capturing, which may at least partially solve the technical problem in the related art that a periodically polling mechanism for web video capturing is subjected to severely poor timeliness and waste of resources.

An embodiment of the present disclosure provides a web video capturing method, including: at an electronic device; collecting related information of various channels, and calculating popularity of the various channels according to the collected related information of the various channels; collecting release time of videos on the various channels to establish a time table for updating the videos; calculating next update time of the videos on the various channels according to the popularity of the various channels and the time table for updating the videos; determining capture time of the videos on the various channels according to the next update time of the videos on the various channels; and capturing the videos on the various channels according to the determined capture time of the videos on the various channels.

An embodiment of the present disclosure further provides a non-volatile computer readable storage medium stored with computer executable instructions, the computer executable instructions perform any one of the method for web video capturing described above in the disclosure.

An embodiment of the present disclosure provides an electronic device, including: at least one processor; and a memory communicably connected with the at least one processor for storing instructions executable by the at least one processor, wherein execution of the instructions by the at least one processor causes the at least one processor to perform any one of the method for web video capturing described above in the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a web video capturing method according to an embodiment of the present disclosure;

FIG. 2 is a schematic structural diagram illustrating a web video capturing apparatus according to an embodiment of the present disclosure; and

FIG. 3 is a block diagram illustrating an electronic device to perform the method for web video capturing according to the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

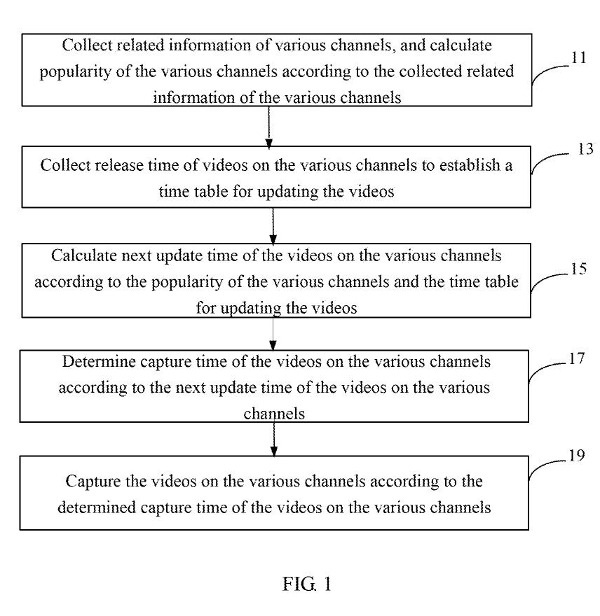

Referring to FIG. 1, a schematic flowchart illustrating a web video capturing method according to an embodiment of the present disclosure is given. The method is applied to a server. The web video capturing method includes:

In step 11: related information of various channels is collected, and popularity of the various channels is calculated according to the collected related information of the various channels;

In step 13: release time of videos on the various channels is collected, and a time table for updating the videos is established;

In step 15: next update time of the videos on the various channels is calculated according to the popularity of the various channels and the time table for updating the videos;

In step 17: capture time of the videos on the various channels is determined according to the next update time of the videos on the various channels; and

In step 19: the videos on the various channels are captured according to the determined capture time of the videos on the various channels.

With the web video capturing method according to the embodiment of the present disclosure, next update time of videos on various channels is calculated according to popularity of a user releasing the videos on the various channels (that is, the popularity of the user on the channels) and time for updating the videos on the various channels of the user releasing the videos, capture time of the videos on the various channels is determined according to the next update time of the videos on the various channels, and thus the videos on the various channels are captured according to the capture time of the videos. Therefore, timeliness of video capturing is high, and the periodically polling mechanism in the related art is not used. In the technical solutions according to the embodiments of the present disclosure, during web video capturing, videos are captured on the webpage at a determined time point, which greatly saves network resources.

Specifically, in the technical solution disclosed in the embodiment illustrating the web video capturing method according to the present disclosure, the collecting related information of various channels includes: collecting a video quantity, a subscription quantity and a total playing quantity on the various channels; and the calculating popularity of the various channels according to the collected related information of the various channels includes: the hot degrees of the various channels is calculated according to the collected video quantity, subscription quantity and total playing quantity on the various channels.

Specifically, in the technical solution disclosed in the embodiment illustrating the web video capturing method according to the present disclosure, the collecting release time of videos on the various channels, and establishing a time table for updating the videos includes: the release time of the videos on the various channels is collected, and time intervals and time periods for updating the various channels each time is calculated, and the time table for updating the videos are established. The time table for updating the videos may be as illustrated in Table 1.

TABLE 1

| Channel | Release time |
|---|---|
| Entertainment | 19:00 Dec. 1, 2015 |
| News | 9:00 Dec. 3, 2015 |

Specifically, in the technical solution disclosed in the embodiment illustrating the web video capturing method according to the present disclosure, the calculating next update time of the videos on the various channels according to the popularity of the various channels and the time table for updating the videos includes: the next update time of the videos on the various channels is calculated according to the popularity of the various channels, and the time intervals and time periods for updating the various channels each time.

In the technical solution disclosed in the embodiment illustrating the web video capturing method according to the present disclosure, the popularity of the various channels refer to the popularity of the user releasing the videos on the websites, that is, the degrees in which the user releasing the videos is concerned on the websites. A high hot degree indicates that the user releasing the videos is more populated on the websites. Calculation of the hot degree may be verified through multiple tests. The hot degree is specifically calculated according to different weights assigned to the collected video quantity, subscription quantity and total playing quantity on a channel. For example, by analyzing user preferences, the weights are sequenced in a descending order as follows: subscription quantity, total playing quantity and video quantity.

Hereinafter a hot user channel is used as an example for description. Step 1: capture a video quantity (video_num), a subscription quantity (fans_num) and a total playing quantity (play_num), and set the hot degree to be fans_num*0.7+play_total*0.2+video_num*0.1; step 2: capture various videos on channels of the user and update time thereof; if the quantity of video is too large, capture latest 10000 pieces of video information, and establish a time table for updating videos according to a corresponding relationship between videos and update time; step 3: analyze the time table for updating videos, analyze user preferences and calculate an update time interval between two videos, and calculate next update time of the videos; step 4: calculate a final update time interval according to the calculated update interval and the hot degree the channel, and acquire final update time by plus the current time.

In the technical solution disclosed in the embodiment illustrating the web video capturing method according to the present disclosure, the method further includes steps: capture time of the videos on the various channels is collected, and the capture time of the videos in the time table for updating the videos is recorded; and an interval between the release time of the videos and the capture time of the videos is calculated; and the calculating next update time of the videos on the various channels according to the popularity of the various channels and the time table for updating the videos further includes steps: the next update time of the videos on the various channels according to the popularity of the various channels, the time intervals and time periods for updating the various channels each time and the interval between the release time of the videos and the capture time of the videos is calculated. In the technical solution according to the embodiment of the present disclosure, an interval between the release time of the videos and the capture time of the videos is calculated, and next update time of the videos is calculated according to the interval between the release time of the videos and the capture time of the videos. To be specific, in the technical solution according to the embodiment of the present disclosure, subsequent determination of next update time of the videos fully considers whether the capture time of previous videos satisfy this factor; thus iterations are continued and the next update time of the videos are constantly adjusted, to hence determine the capture time of the videos. Therefore, the capture time of the videos in this technical solution is more and more actuate, and timeliness of video capturing is higher and higher. In addition, since the capture time of the videos is controlled accurately, network resources are not wasted, and thus more network resources are maintained.

Specifically, in the technical solution disclosed in the embodiment illustrating the web video capturing method according to the present disclosure, upon the capturing the videos on the various channels according to the determined capture time of the videos on the various channels, the method further includes: information of the captured videos on the various channels is stored.

Specifically, in the technical solution disclosed in the embodiment illustrating the web video capturing method according to the present disclosure, upon the capturing the videos on the various channels according to the determined capture time of the videos on the various channels, the method further includes: the captured videos on the various channels to a user is recommended.

In the technical solution disclosed in the embodiment illustrating the web video capturing method according to the present disclosure, upon video capturing, key information of the captured videos may be stored, wherein the key information may include links of the videos, capture time of the videos, popularity (a playing quantity, a like-giving quantity, and a visit quantity) of the videos and the like. Upon detection that a user logs in to a video webpage, stored videos may be recommended to the logged user. The specific process of recommending videos to the user may be recommending the stored videos to the user in a sequence based on the video capture time, or may be recommending the stored videos to the user in a sequence based on hot degree, or may be recommending links of the stored videos to the user in a hybrid sequence of both the capture time and the popularity of the videos. Recommending videos to the logged user fully considers the demands of the user, which may enhance user experience and give great convenient to the user.

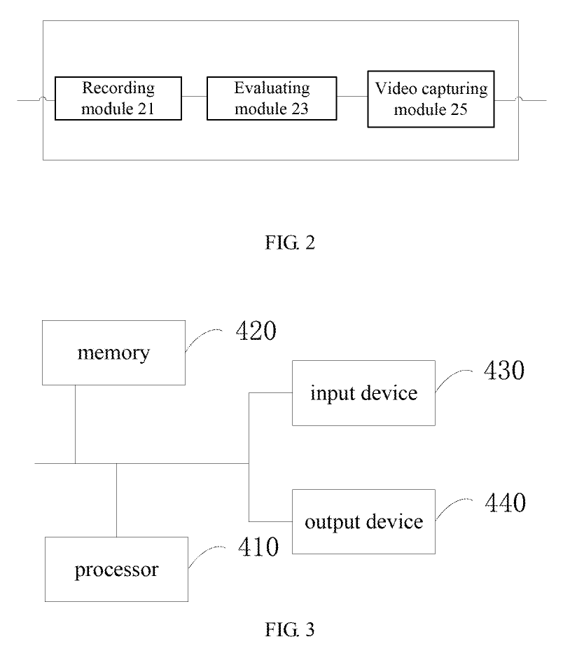

Referring to FIG. 2, a schematic structural diagram illustrating a web video capturing apparatus according to an embodiment of the present disclosure is given. The apparatus is applied to a server. The apparatus includes: a recording module 21, an evaluating module 23 and a video capturing module 25.

The recording module 21 collects related information of various channels, and calculates popularity of the various channels according to the collected related information of the various channels; and collects release time of videos on the various channels to establish a time table for updating the videos.

The evaluating module 23 calculates next update time of the videos on the various channels according to the popularity of the various channels and the time table for updating the videos, and determines capture time of the videos on the various channels according to the next update time of the videos on the various channels.

The video capturing module 25 captures the videos on the various channels according to the determined capture time of the videos on the various channels.

With the web video capturing apparatus according to the embodiment of the present disclosure, next update time of videos on various channels is calculated according to popularity of the various channels and time for updating the videos on the various channels, capture time of the videos on the various channels is determined according to the next update time of the videos on the various channels, and thus the videos on the various channels are captured according to the capture time of the videos. Therefore, timeliness of video capturing is high, and the periodically polling mechanism in the related art is not used. In the technical solutions according to the embodiments of the present disclosure, during web video capturing, videos are captured on the webpage only at a determined time point, which greatly saves network resources.

Specifically, in the technical solution disclosed in the embodiment illustrating the web video capturing apparatus according to the present disclosure, the recording module 21 collects a video quantity, a subscription quantity and a total playing quantity on the various channels; and calculates the popularity of the various channels according to the collected video quantity, subscription quantity and total playing quantity on the various channels.

Specifically, in the technical solution disclosed in the embodiment illustrates the web video capturing apparatus according to the present disclosure, the recording module 21 further collects the release time of the videos on the various channels, calculates time intervals and time periods for updating the various channels each time, and establishes the time table for updating the videos by the recording module 21.

Specifically, in the technical solution disclosed in the embodiment illustrates the web video capturing apparatus according to the present disclosure, the evaluating module 23 further calculates the next update time of the videos on the various channels according to the popularity of the various channels, and calculates the time intervals and time periods for updating the various channels each time

Specifically, in the technical solution disclosed in the embodiment illustrating the web video capturing apparatus according to the present disclosure, the recording module 21 further collects capture time of the videos on the various channels, and records the capture time of the videos in the time table for updating the videos; and calculates an interval between the release time of the videos and the capture time of the videos; and the evaluating module 23 further calculates the next update time of the videos on the various channels according to the popularity of the various channels, calculates the time intervals and time periods for updating the various channels each time and the interval between the release time of the videos and the capture time of the videos.

Specifically, in the technical solution disclosed in the embodiment illustrating the video capturing module 25 further stores information of the captured videos on the various channels.

Specifically, in the technical solution disclosed in the embodiment illustrating the video capturing module 25 further recommends the captured videos on the various channels to a user.

With the web video capturing apparatus according to the embodiment of the present disclosure, next update time of videos on various channels is calculated according to popularity of the various channels and time for updating the videos on the various channels, capture time of the videos on the various channels is determined according to the next update time of the videos on the various channels, and thus the videos on the various channels are captured according to the capture time of the videos. Therefore, timeliness of video capturing is high, and the periodically polling mechanism in the related art is not used. In the technical solutions according to the embodiments of the present disclosure, during web video capturing, videos are captured on the webpage only at a determined time point, which greatly saves network resources.

The embodiments of the disclosure also provides a non-volatile computer storage medium storing computer-executable instructions which are used to perform some or all steps in various implementations of the method for web video capturing described above in the method embodiments

FIG. 3 is a schematic diagram of hardware structure of an electronic device used to perform the method for web video capturing according to an embodiment of the present disclosure, as shown in FIG. 3, the device includes:

at least one processor 410 and a memory 420, FIG. 3 illustrates one processor 410 as an example.

The device for the method for web video capturing may further include an input device 430 and an output device 440.

The processor 410, the memory 420, the input device 430 and the output device 440 may be connected with each other through bus or other forms of connections. FIG. 3 illustrates bus connection as an example.

As a non-volatile computer-readable storage medium, the memory 420 may be configured to store non-volatile software program, non-volatile computer executable program and modules, such as program instructions/modules corresponding to the method for web video capturing according to the embodiments of the disclosure (for example, the recording module 21, evaluating module 23 and the video capturing module 25 as illustrated in FIG. 2). By executing the non-volatile software program, instructions and modules stored in the memory 420, the processor 410 may perform various functional applications of the server and data processing, that is, the method for web video capturing according to the above mentioned embodiments.

The memory 420 may include a program storage area and a data storage area, wherein, the program storage area may be stored with the operating system and applications which are needed by at least one functions, and the data storage area may be stored with data which is created according to use of the device for web video capturing. Further, the memory 420 may include a high-speed random access memory, and may further include non-volatile memory, such as at least one of disk memory device, flash memory device or other types of non-volatile solid state memory device. In some embodiments, optionally, the memory 420 may include memory provided remotely from the processor 410, and such remote memory may be connected with the device for web video capturing through network connections, the examples of the network connections may include but not limited to internet, intranet, LAN (Local Area Network), mobile communication network or combinations thereof.

The input device 430 may receive inputted number or character information, and generate key signal input related to the user settings and functional control of the device for web video capturing. The output device 440 may include a display device such as a display screen.

The above one or more modules may be stored in the memory 420, when these modules are executed by the one or more processors 410, the method for web video capturing according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A web video capturing method, comprising: at an electronic device:
collecting related information of various channels, and calculating popularity of the various channels according to the collected related information of the various channels;
collecting release time of videos on the various channels to establish a time table for updating the videos;
calculating next update time of the videos on the various channels according to the popularity of the various channels and the time table for updating the videos;
determining capture time of the videos on the various channels according to the next update time of the videos on the various channels; and
capturing the videos on the various channels according to the determined capture time of the videos on the various channels.

2. The method according to claim 1, wherein,
The step of collecting related information of various channels comprises: collecting number of videos, number of subscriptions and total times of playing on the various channels; and
the calculating popularity of the various channels according to the collected related information of the various channels comprises: calculating the popularity of the various channels according to the number of videos collected, the number of subscriptions collected and the total times of playing collected on the various channels.

3. The method according to claim 1, wherein
the step of collecting release time of videos on the various channels, and establishing the time table for updating the videos comprises: collecting the release time of the videos on the various channels, calculating time intervals and time periods for updating the various channels each time, and establishing the time table for updating the videos.

4. The method according to any one of claim 1, wherein
the step of calculating next update time of the videos on the various channels according to the popularity of the various channels and the time table for updating the videos comprises: calculating the next update time of the videos on the various channels according to the popularity of the various channels, and the time intervals and the time periods for updating the various channels each time.

5. The method according to claim 4, further comprising:
collecting capture time of the videos on the various channels, recording the capture time of the videos in the time table for updating the videos; and calculating an interval between the release time of the videos and the capture time of the videos; and
the calculating next update time of the videos on the various channels according to the popularity of the various channels and the time table for updating the videos further comprises: calculating the next update time of the videos on the various channels according to the popularity of the various channels, the time intervals and the time periods for updating the various channels each time and the interval between the release time of the videos and the capture time of the videos.

6. The method according to claim 1, wherein
after the step of capturing the videos on the various channels according to the determined capture time of the videos on the various channels, the method further comprises: storing information of the videos captured on the various channels.

7. The method according to claim 6, wherein
after the step of storing information of the captured videos on the various channels, the method further comprises: recommending the videos captured on the various channels to a user.

8. An electronic device, comprising:
at least one processor; and
a memory communicably connected with the at least one processor for storing instructions executable by the at least one processor, wherein execution of the instructions by the at least one processor causes the at least one processor to:
collect related information of various channels, and calculate popularity of the various channels according to the collected related information of the various channels; and collect release time of videos on the various channels to establish a time table for updating the videos;
calculate next update time of the videos on the various channels according to the popularity of the various channels and the time table for updating the videos, and determine capture time of the videos on the various channels according to the next update time of the videos on the various channels; and
capture the videos on the various channels according to the determined capture time of the videos on the various channels.

9. The electronic device according to claim 8, wherein,
the instructions to collect related information of various channels cause the at least one processor to:
collect number of videos, number of subscriptions and total times of playing on the various channels; and
the instructions to calculate popularity of the various channels according to the collected related information of the various channels cause the at least one processor to: calculate the popularity of the various channels according to the number of videos collected, the number of subscriptions collected and the total times of playing collected on the various channels.

10. The electronic device according to claim 8, wherein,
the instructions to collect release time of videos on the various channels, and establish the time table for updating the videos cause the at least one processor to:
collect the release time of the videos on the various channels, calculate time intervals and time periods for updating the various channels each time, and establish the time table for updating the videos.

11. The electronic device according to claim 8, wherein,
the instructions to calculate next update time of the videos on the various channels according to the popularity of the various channels and the time table for updating the videos by the evaluating module cause the at least one processor to:
calculate the next update time of the videos on the various channels according to the popularity of the various channels, and the time intervals and the time periods for updating the various channels each time.

12. The electronic device according to claim 8, wherein, the at least one processor is further caused to:
collect capture time of the videos on the various channels, record the capture time of the videos in the time table for updating the videos; and calculate an interval between the release time of the videos and the capture time of the videos; and
the instructions to calculate next update time of the videos on the various channels according to the popularity of the various channels and the time table for updating the videos cause the at least one processor to: calculate the next update time of the videos on the various channels according to the popularity of the various channels, the time intervals and time periods for updating the various channels each time and the interval between the release time of the videos and the capture time of the videos by the evaluating module.

13. The electronic device according to claim 8, wherein,
the at least one processor is further caused to: store information of the captured videos on the various channels by the video capturing module.

14. The electronic device according to claim 1, wherein,
the at least one processor is further caused to: store information of the captured videos on the various channels by the video capturing module.

15. A non-volatile computer-readable storage medium storing executable instructions that, when executed by an electronic device with a touch-sensitive display, cause the electronic device to:
collect related information of various channels, and calculate popularity of the various channels according to the collected related information of the various channels; and collect release time of videos on the various channels to establish a time table for updating the videos;
calculate next update time of the videos on the various channels according to the popularity of the various channels and the time table for updating the videos, and determine capture time of the videos on the various channels according to the next update time of the videos on the various channels; and
capture the videos on the various channels according to the determined capture time of the videos on the various channels.

16. The non-volatile computer-readable storage medium according to claim 15, wherein,
the instructions to collect related information of various channels by the calculating module cause the at least one processor to:
collect number of videos, number of subscriptions and total times of playing on the various channels; and
the instructions to calculate popularity of the various channels according to the collected related information of the various channels cause the at least one processor to: calculate the popularity of the various channels according to the number of videos collected, the number of subscriptions collected and the total times of playing collected on the various channels.

17. The non-volatile computer-readable storage medium according to claim 15, wherein,
the instructions to collect release time of videos on the various channels, and establish the time table for updating the videos b cause the at least one processor to:
collect the release time of the videos on the various channels, calculate time intervals and time periods for updating the various channels each time, and establish the time table for updating the videos by the recording module.

18. The non-volatile computer-readable storage medium according to claim 15, wherein,
the instructions to calculate next update time of the videos on the various channels according to the popularity of the various channels and the time table for updating the videos cause the at least one processor to:
calculate the next update time of the videos on the various channels according to the popularity of the various channels, and the time intervals and the time periods for updating the various channels each time.

19. The non-volatile computer-readable storage medium according to claim 15, wherein, the at least one processor is further caused to:
collect capture time of the videos on the various channels, record the capture time of the videos in the time table for updating the videos; and calculate an interval between the release time of the videos and the capture time of the videos; and
the instructions to calculate next update time of the videos on the various channels according to the popularity of the various channels and the time table for updating the videos cause the at least one processor to: calculate the next update time of the videos on the various channels according to the popularity of the various channels, the time intervals and time periods for updating the various channels each time and the interval between the release time of the videos and the capture time of the videos.

20. The non-volatile computer-readable storage medium according to claim 15, wherein,
the at least one processor is further caused to: store information of the captured videos on the various channels
